(19) United States
(12) Patent Application Publication
(10) Pub. No.: US 2003/0135652 A1
(43) Pub. Date: Jul. 17, 2003

(54) Multi-media network system having intelligent driver

(76) Inventor: Roger Wu, Hsin Chuang City (TW)

Correspondence Address: Roger Wu, P.O. Box 4-67, Hsin Chuang, Taipei, 242, TW

(21) Appl. No.: 10/045,077

(22) Filed: Jan. 15, 2002

(51) Int. Cl. G06F 15/16

(52) U.S. Cl. 709/250; 709/249

(57) ABSTRACT

A multi-media network system includes a processor device, a first memory coupled to the processor device, a static random access memory coupled to the processor device, an I/O coupled to the processor device for controlling the processor device, a power supply for energizing the processor device, and a number of couplers coupled to the processor device for coupling to various kinds of media. A single intelligent driver electronic device may be used and coupled to the processor device for coupling or entering into the various kinds of media.

### BACKGROUND OF THE INVENTION

1. Field of the Invention

The present invention relates to a computer or a network system, and more particularly to a multi-media network system having an intelligent driver device.

2. Description of the Prior Art

Typical multi-media network systems comprise a computer device or a processor device for coupling to or for entering into various kinds of network systems or apparatus, such as the asymmetrical digital subscriber line (ADSL), the voice over internet protocol (VOIP), the cable modem, the integrated services digital network (ISDN), the X digital subscriber line (XDSL), . . . etc. However, the users have to purchase and couple a number of interface products or interface cards or the like for the respective network systems.

The present invention has arisen to mitigate and/or obviate the afore-described disadvantages of the conventional network systems.

### SUMMARY OF THE INVENTION

The primary objective of the present invention is to provide a multi-media network system having an intelligent driver device for coupling to various kinds of media with a single interface device.

In accordance with one aspect of the invention. there is provided a multi-media network system comprising a processor device, a first memory coupled to the processor device, a static random access memory coupled to the processor device, an I/O coupled to the processor device for controlling the processor device, means for energizing the processor device, an intelligent driver electronic device coupled to the processor device, and a plurality of couplers coupled to the processor device for coupling to various kinds of media.

One or more bridges may further be provided and coupled between the couplers and the processor device. One or more light devices may further be provided and coupled to the processor device for generating indicating light.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a block diagram illustrating the network system in accordance with the present invention; and

FIG. 2 is a block diagram similar to FIG. 1, illustrating the application of the network system.

### DETAILED DESCRIPTION OF THE PREFERRED EMBODIMENT

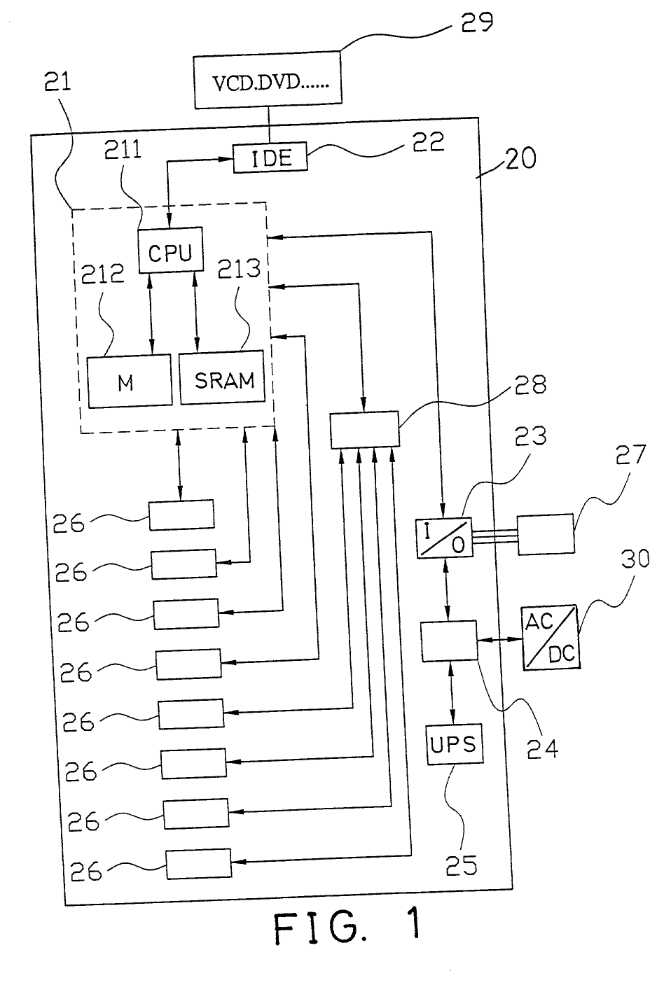

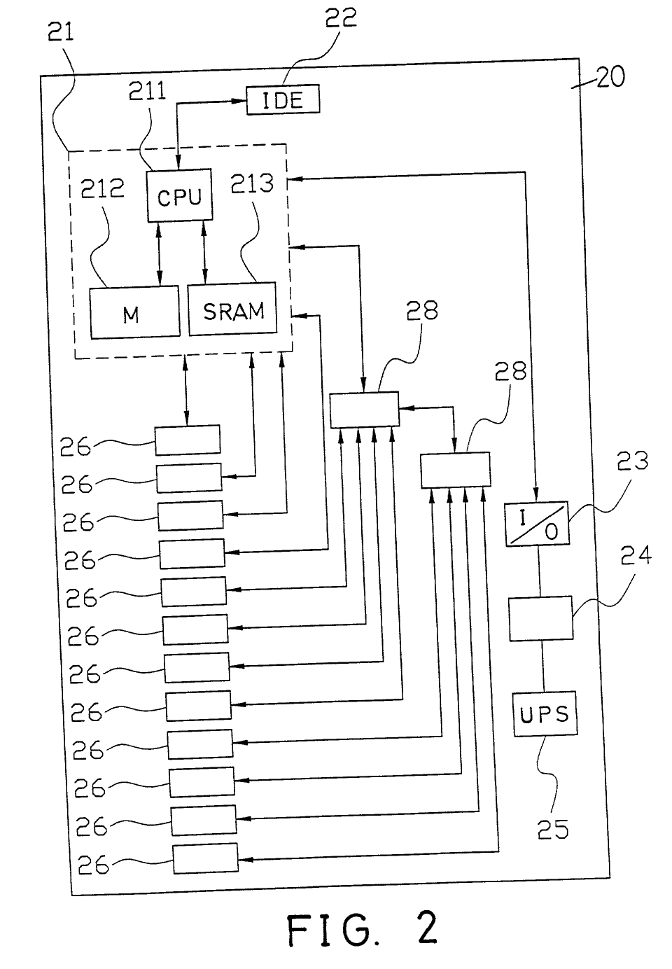

Referring to the drawings, and initially to FIG. 1, a multi-media network system in accordance with the present invention comprises a computer device 20 including a processor device 21 having such as a central processing unit (CPU) 211, a memory, such as a flash memory 212 coupled to the CPU 211, and/or a static random access memory (SRAM) 213 coupled to the CPU 211. The computer device 20 may include a number of slots or plugs or couplers 26 coupled thereto or provided therein for coupling to various kinds of the network systems, such as the ADSL, the VOIP, the cable modem, the ISDN, the XDSL, the optical fiber, the television tuner, the wireless local area network (WLAN), the motion picture experts group layer 2 (MPEG2), etc. The couplers 26 may be directly coupled to the processor device 21, or indirectly via one bridge (FIG. 1), or one or more bridges or bridge devices 28 (FIG. 2).

The CPU 211 of the processor device 21 may be coupled to the other media, such as the VCD, the DVD, the recorder, etc., via an intelligent driver electronics (IDE). An input/output (I/O) 23 is coupled to the processor device 21 for entering data or for controlling the processor device 21. A power supply 24 and/or a uninterruptible power supply (UPS) 25 may be provided and coupled to the processor device 21 for energizing the processor device 21. The power supply 24 may include one or more batteries, or may be coupled to another power supply via a AC/DC converter 30. One or more indicating light devices 27 may further be provided and coupled to the computer device 20 or to the I/O 23, for indicating that the network system is being used.

Accordingly, the various kinds of the network systems may be coupled to the processor device 21 via the couplers 26, and then may be entered or used with a single IDE which occupies a relatively smaller volume. For the typical network systems, the users have to purchase and couple a number of interface products or interface cards or the like for the respective network systems which may occupy a relatively greater volume.

Accordingly, the multi-media network system in accordance with the present invention includes an intelligent driver device for coupling to various kinds of media with a single interface device.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A multi-media network system comprising:
a processor device,
a first memory coupled to said processor device,
a static random access memory coupled to said processor device,
an I/O coupled to said processor device for controlling said processor device,
means for energizing said processor device,
an intelligent driver electronic device coupled to said processor device, and
a plurality of couplers coupled to said processor device for coupling to various kinds of media.

2. The multi-media network system according to claim 1 further comprising at least one bridge coupled between said couplers and said processor device.

3. The multi-media network system according to claim 2 further comprising at least one light device coupled to said processor device for generating indicating light.
